(19) United States
(12) Patent Application Publication
(10) Pub. No.: US 2010/0045640 A1
(43) Pub. Date: Feb. 25, 2010

(54) DISPLAY DEVICE AND METHOD OF DRIVING THE SAME

(75) Inventors: Hee-Bum Park, Seongnam-si (KR); Bong-Hyun You, Yongin-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/540,159

(22) Filed: Aug. 12, 2009

(30) Foreign Application Priority Data
Aug. 22, 2008 (KR) 10-2008-0082483

(51) Int. Cl. G09G 5/00; G02F 1/1335

(52) U.S. Cl. 345/205; 349/96

(57) ABSTRACT

The present invention provides a display device which can display a clear stereoscopic image by distinctly separating a left image from a right image, and a method of driving the display device. The display device includes a display panel that sequentially displays a left image and a right image, and a polarizing panel disposed on the display panel, the polarizing panel to change a polarization direction of at least one of the left image and the right image so that polarization directions of the left image and the right image are different from each other. Each left image and a right image includes a black image.

### CROSS REFERENCE TO RELATED APPLICATION

This application claims priority from and the benefit of Korean Patent Application No. 10-2008-0082483, filed on Aug. 22, 2008, which is hereby incorporated by reference for all purposes as if fully set forth herein.

### BACKGROUND OF THE INVENTION

1. Field of the Invention

The present invention relates to a display device and a method of driving the same, and more particularly, to a display device which can display a clear stereoscopic image by distinctly separating a left image from a right image and a method of driving the display device.

2. Discussion of the Background

As modern society becomes more dependent on sophisticated information and communication technology, the market need for larger and thinner display devices grows. In particular, since conventional cathode ray tubes (CRTs) have failed to fully satisfy this market need, the demand for flat panel displays (FPDs), such as plasma display panels (PDPs), plasma address liquid crystal display panels (PALCs), liquid crystal displays (LCDs), and organic light emitting diodes (OLLDs), is exploding.

Recently, the image quality of display devices has improved to such an extent that the display devices can display an image that simulates a real object. In addition, display devices that can display not only two-dimensional (2D) but also three-dimensional (3D) images are being developed. Display devices that can display 3D images enable viewers to perceive a stereoscopic image by using binocular parallax.

In order to perceive or produce a 3D stereoscopic image, special glasses or holograms may be used. Alternatively, a lenticular sheet, a polarization-switching panel, or a barrier may be used.

When a polarization-switching panel is used to produce a stereoscopic image, it may be attached onto a display panel to separate a left image from a right image. If the left and right images are not clearly separated from each other but overlap each other for a period of time, a clear stereoscopic image may not be displayed on the display device. Therefore, a display device, which is structured to clearly separate the left image from the right image, and a method of clearly separating the left image from the right image may be required.

### SUMMARY OF THE INVENTION

The present invention provides a display device that can display a clear stereoscopic image by distinctly separating a left image from a right image.

The present invention also provides a method of driving a display device that can display a clear stereoscopic image by distinctly separating a left image from a right image.

Additional features of the invention will be set forth in the description which follows, and in part will be apparent from the description, or may be learned by practice of the invention.

The present invention discloses a display device including a display panel which sequentially displays a left image and a right image, and a polarizing panel that is disposed on the display panel, the polarizing panel to change a polarization direction of at least one of the left image and the right image so that polarization directions of the left image and the right image are different from each other. Each left image and a right image includes a black image.

The present invention also discloses a method of driving a display device. The method includes sequentially displaying a left image and a right image on a display panel, passing the left image and right image displayed on the display panel through a polarizing film to polarize the left image and right image, and passing the left image and right image, which passed through the polarizing film, through a polarizing panel to change a polarization direction of at least one of the left image and the right image so that polarization directions of the left image and right image are different from each other. Each left image and right image includes a black image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a display device according to an exemplary embodiment of the present invention.

FIG. 2 is a schematic exploded perspective view showing the operation of the display device shown in FIG. 1.

FIG. 3A and FIG. 3B are schematic perspective views showing the process of perceiving a stereoscopic image displayed on the display device of FIG. 1.

FIG. 4 is a schematic block diagram showing a method of driving the display device shown in FIG. 1.

FIG. 5A is a block diagram of an image signal transmitted to the display device of FIG. 1.

FIG. 5B shows waveforms of signals transmitted to the display device of FIG. 1.

FIG. 6 is a perspective view of a polarizing panel included in a display device according to another exemplary embodiment of the present invention.

FIG. 7A, FIG. 7B, FIG. 7C, and FIG. 7D are plan views of the display device showing the process of displaying a left image and a right image on the display panel shown in FIG. 6.

FIG. 8 shows waveforms of signals transmitted to the display device according to other exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Spatially relative terms, such as “below”, “beneath”, “lower”, “above”, “upper”, and the like, may be used herein for ease of description to describe one element or feature's relationship to another element(s) or feature(s) as shown in the figures. It will be understood that the spatially relative terms are intended to encompass different orientations of the device in use or operation in addition to the orientation depicted in the figures.

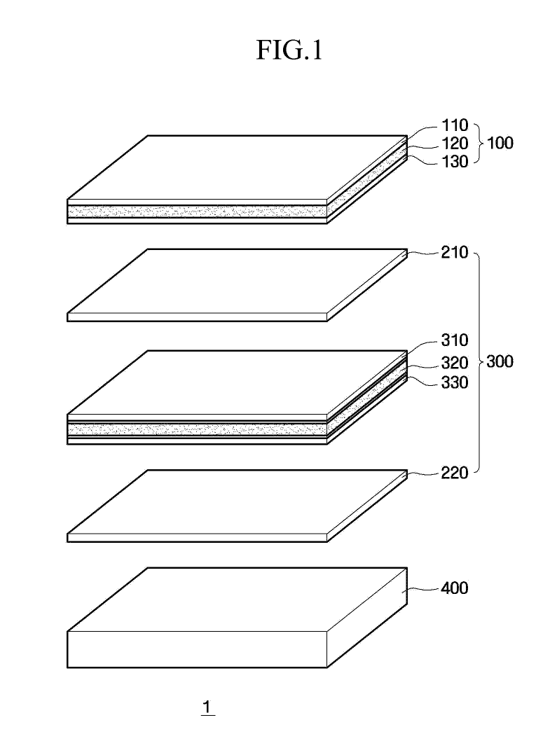

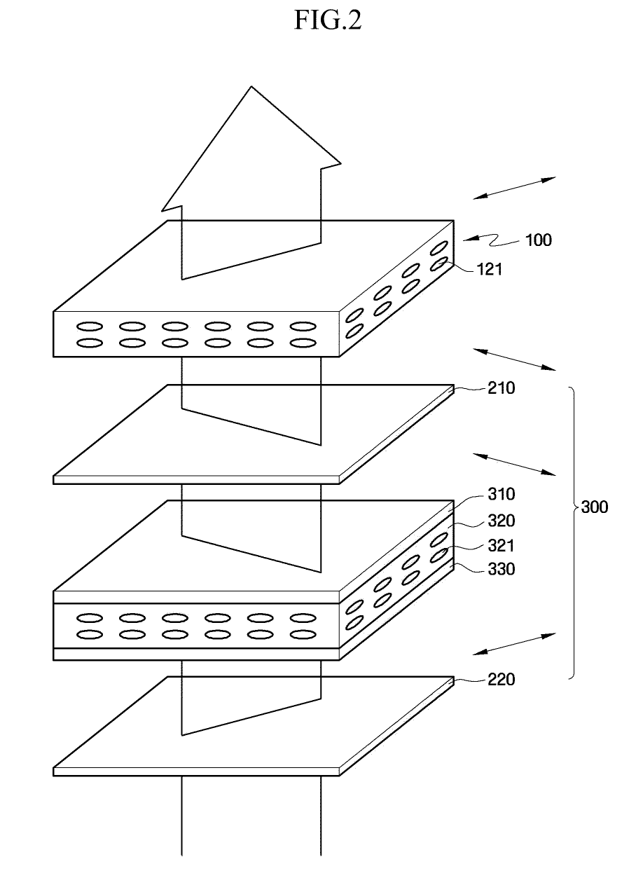

Hereinafter, a display device according to an exemplary embodiment of the present invention will be described in detail with reference to FIG. 1 and FIG. 2. FIG. 1 is an exploded perspective view of a display device 1, i.e., a liquid crystal display (LCD), according to an exemplary embodiment of the present invention. FIG. 2 is a schematic exploded perspective view showing the operation of the display device 1 shown in FIG. 1.

The display device 1 according to the present exemplary embodiment includes a backlight unit 400, a display panel 300, and a polarizing panel 100.

The backlight unit 400 includes light sources and provides light to the display panel 300. The backlight unit 400 may include various optical members that provide light to the display panel 300. For example, when the backlight unit 400 is a direct-type backlight unit, it may include a diffusion plate and various optical sheets. When the backlight unit 400 is an edge-type backlight unit, the light sources may be arranged at one or more sides of a light guide plate, and optical sheets may be disposed on the light guide plate.

The light sources included in the backlight unit 400 may be cold cathode fluorescent lamps (CCFLs) or light-emitting diodes (LEDs).

The display panel 300 is disposed on the backlight unit 400 structured as described above. The display panel 300 displays images. Specifically, the display panel 300 sequentially displays a left image and a right image. The left and right images may be displayed for a frame or less than a frame. In addition, each of the left and right images includes a black image. Images displayed on the display panel 300 and image signals will be described in detail below.

The display panel 300 includes a lower display panel 330, which includes a thin-film transistor (TFT) array, an upper display panel 310, which faces the lower display panel 330, a first liquid crystal layer 320, which is disposed between the lower and upper display panels 330 and 310, a first polarizing film 220, which is disposed under the lower display panel 330, and a second polarizing film 210, which is disposed on the upper display panel 310. The first and second polarizing films 220 and 210 may be described as components of the display panel 300. The first and second polarizing films 220 and 210 may be described as additional components of the display panel 300.

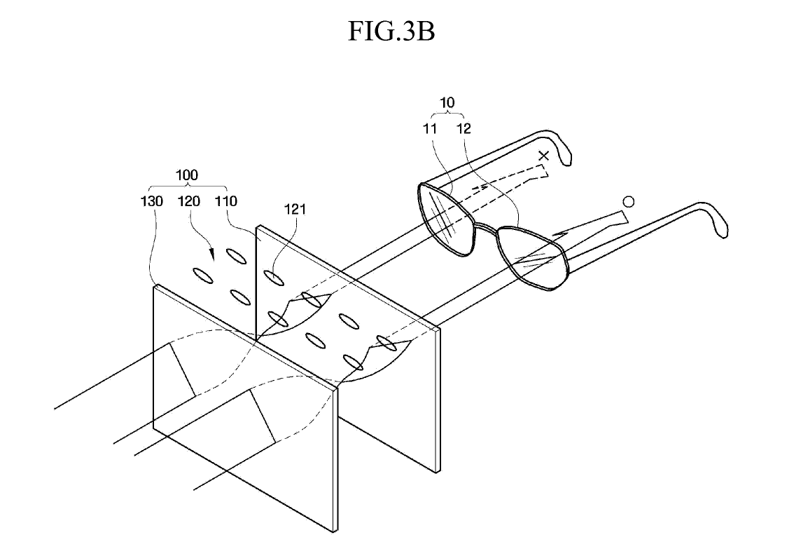

The display panel 300 includes a plurality of pixels PX (see FIG. 4), and each pixel PX displays a basic unit of an image and is controlled by a switching device (not shown) such as a TFT. Each pixel PX includes two electrodes that face each other, and liquid crystal molecules 321 in the first liquid crystal layer 320 are oriented by an electric field that is applied between the two electrodes. In addition, the amount of light that passes through the display panel 300 is controlled by the orientation of the first liquid crystal layer 320.

The display panel 300 includes two sheets of polarizing films, i.e., the first and second polarizing films 220 and 210. The first polarizing film 220 is disposed between the lower display panel 330 and the backlight unit 400, and the second polarizing film 210 is disposed between the upper display panel 310 and the polarizing panel 100, which will be described below.

The first polarizing film 220 polarizes light from the backlight unit 400 in a predetermined direction and outputs the polarized light. Here, the polarized light may be linearly polarized light. The polarization direction of the polarized light changes as the polarized light passes through the first liquid crystal layer 320. Then, as the polarized light passes through the second polarizing film 210, an image is displayed on the display panel 300.

Since the display panel 300 includes the first and second polarizing films 220 and 210 on both surfaces thereof, it can display a desired grayscale image by changing the orientation of the liquid crystal molecules 321 in the first liquid crystal layer 320.

The polarizing panel 100 is disposed on the display panel 300 and changes a polarization direction of each of left and right images received from the display panel 300. The polarizing panel 100 includes a first switching substrate 130, a second switching substrate 110, and a second liquid crystal layer 120 that is disposed between the first and second switching substrates 130 and 110.

An image output from the display panel 300 is polarized in a certain direction. That is, a polarized image is output from the display panel 300 and provided to the polarizing panel 100. Here, the polarizing panel 100 changes the polarization direction of the polarized image. Thus, an image output from the polarizing panel 100 is separated into left and right images, which are separated from each other. The left and right images are polarized in different directions.

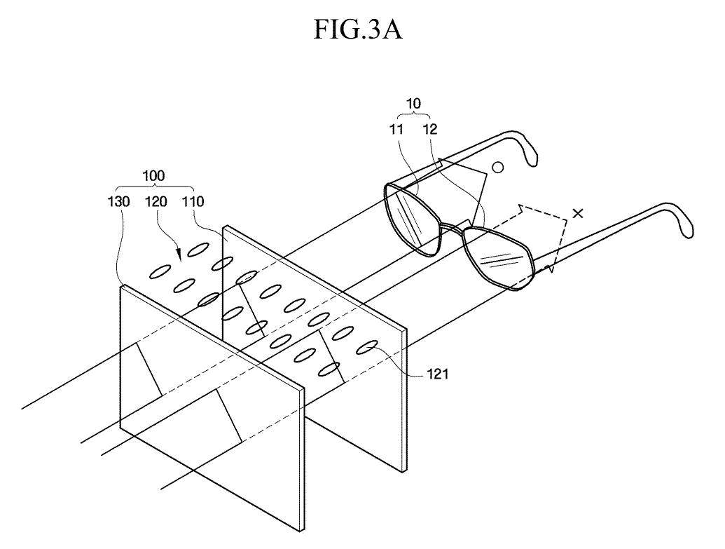

Since the left and right images are polarized in different directions, a viewer can perceive a stereoscopic image by using polarized glasses 10 (see FIG. 3A). The process of perceiving a stereoscopic image will be described in detail below.

Each of the first switching substrate 130 and the second switching substrate 110 includes a transparent electrode (not shown) formed on the entire surface thereof. When an electric field is applied to each of the transparent electrodes, liquid crystal molecules 121 in the second liquid crystal layer 120, which is disposed between the transparent electrodes, are oriented. When the liquid crystal molecules 121 in the second liquid crystal layer 120 are oriented, the polarization direction of light that passes through the polarizing panel 100 is changed. The polarizing panel 100 performs a switching operation at each frame of an image signal to change the polarization direction of an image.

A process in which the polarization direction of light is changed as the light passes through the display panel 300 and the polarizing panel 100 will now be described in detail with reference to FIG. 2.

The wide arrow shown in FIG. 2 indicates a polarization direction of light that may pass through each component of the display device 1. Polarization directions shown in FIG. 2 are exemplary. That is, each component of the display device 1 may have polarization axes in other directions. The polarization direction of light that may pass through each of the display panel 300 and the polarizing panel 100 may be changed.

Light incident on the first polarizing film 220 may be natural light that is not polarized. As the natural light passes through the first polarizing film 220, it is polarized in a certain direction. Here, a polarization axis of the second polarizing film 210 is orthogonal to that of the first polarizing film 220. Therefore, the light output from the first polarizing film 220 cannot pass through the second polarizing film 210. However, the first liquid crystal layer 320 of the display panel 300 can change the polarization direction of the light that passed through the first polarizing film 220 to the direction of the polarization axis of the second polarizing film 210. Since the first liquid crystal layer 320 can adjust the polarization direction of the light that passed through the first polarizing film 220 to the direction of the polarization axis of the second polarizing film 210, the transmittance of the light through the second polarizing film 210 can be controlled.

The polarization direction of the light that passes through the second polarizing film 210 is the same as the direction of the polarization axis of the second polarizing film 210. The polarization direction of the light that passes through the second polarizing film 210 may be adjusted again by the polarizing panel 100.

The process of perceiving a stereoscopic image displayed on the display device 1 according to the present exemplary embodiment will now be described in detail with reference to FIG. 3A and FIG. 3B. FIG. 3A and FIG. 3B are schematic perspective views showing the process of perceiving a stereoscopic image displayed on the display device 1 of FIG. 1.

First, the process of perceiving a right image will be described with reference to FIG. 3A. A right image denotes an image perceived by the right eye, and a left image denotes an image perceived by the left eye. In order to perceive a stereoscopic image, the left and right eyes must see different images. Thus, the left and right images must be displayed properly on the display device 1, that is, the left and right images must be displayed so that they are clearly distinct.

When a right image is displayed on the display panel 300, it is incident on the polarizing panel 100. The right image incident on the polarizing panel 100 passes through the first switching substrate 130, the second liquid crystal layer 120, and the second switching substrate 110 to reach the polarized glasses 10. Specifically, the right image displayed on the display panel 300 is an image that passed through the second polarizing film 210. Thus, the right image is polarized in a predetermined direction and displayed accordingly. The right image polarized in the predetermined direction is incident on the first switching substrate 130. Since the first switching substrate 130 is a transparent substrate, which includes a transparent electrode, the right image polarized in the predetermined direction remains unchanged when passing through the first switching substrate 130.

Next, the right image that passed through the first switching substrate 130 passes through the second liquid crystal layer 120. For example, liquid crystal molecules 121 in the second liquid crystal layer 120 may be aligned perpendicular to the first and second switching substrates 130 and 1 10. In this case, if no electric field is applied to the second liquid crystal layer 120, the liquid crystal molecules 121 remain perpendicular to the first and second switching substrates 130 and 1 10. When the liquid crystal molecules 121 are aligned perpendicular to the first and second switching substrates 130 and 110, the phase of light that passes through the second liquid crystal layer 120 remains unchanged. Therefore, the polarization direction of the right image that passes through the second liquid crystal layer 120 is the same as the direction of the polarization axis of the second polarizing film 210.

Next, the right image that passed through the second liquid crystal layer 120 passes through the second switching substrate 110. Like the first switching substrate 130, the second switching substrate 110 is a transparent substrate that includes a transparent electrode. Thus, the second switching substrate 110 may not have a polarizing function.

Consequently, when the right image that passed through the second polarizing film 210 passes through the polarizing panel 100, its polarization direction remains unchanged. Thus, the right image, which is polarized in the same direction as the direction of the polarization axis of the second polarizing film 210, reaches the polarized glasses 10.

The polarized glasses 10 of a viewer include a first polarizing lens 11 and a second polarizing lens 12. Each of the first and second polarizing lenses 11 and 12 may have a polarizing function. The first and second polarizing lenses 11 and 12 may have polarization axes that cross each other. In order to improve polarization efficiency, a polarization axis of the first polarizing lens 11 may be orthogonal to that of the second polarizing lens 12.

A right lens of the polarized glasses 10 may be the first polarizing lens 11, and a left lens of the polarized glasses 10 may be the second polarizing lens 12. In this case, the direction of the polarization axis of the first polarizing lens 11 may be the same as the polarization direction of the right image that passed though the second switching substrate 110. Therefore, the right image that passed through the second switching substrate 110 can pass through the first polarizing lens 11 and reach the right eye of the viewer. On the other hand, since the polarization direction of the right image is different from the polarization axis of the second polarizing lens 12, the right image cannot pass through the second polarizing lens 12. Consequently, while the viewer can see the right image with his right eye through the first polarizing lens 11, he cannot see the right image with his left eye.

Next, the process of perceiving a left image will be described in detail with reference to FIG. 3B.

When a left image is displayed on the display panel 300, it is incident on the polarizing panel 100. The left image incident on the polarizing panel 100 passes through the first switching substrate 130, the second liquid crystal layer 120, and the second switching substrate 110 to reach the polarized glasses 10. Specifically, the left image displayed on the display panel 300 is an image that passed through the second polarizing film 210. Thus, the left image is polarized in a predetermined direction and displayed accordingly. The left image polarized in the predetermined direction is incident on the first switching substrate 130. Since the first switching substrate 130 is a transparent substrate, which includes a transparent electrode, the left image polarized in the predetermined direction remains unchanged when passing through the first switching substrate 130.

Next, the left image that passed through the first switching substrate 130 passes through the second liquid crystal layer 120. As described above, the liquid crystal molecules 121 in the second liquid crystal layer 120 may be aligned perpendicular to the first and second switching substrates 130 and 110. In this case, if an electric field is applied to the second liquid crystal layer 120, the liquid crystal molecules 121 are aligned parallel to the first and second switching substrates 130 and 110. When the liquid crystal molecules 121 are aligned parallel to the first and second switching substrates 130 and 110, the phase of light that passes through the second liquid crystal layer 120 is changed by the liquid crystal molecules 121. As a result, the polarization direction of the light changes. As shown in FIG. 3B, when the left image passes through the second liquid crystal layer 120, its polarization direction may be rotated 90 degrees. Thus, the left image having the polarization direction rotated 90 degrees may be input to the second switching substrate 110. That is, the polarization direction of the left image that passes through the second liquid crystal layer 120 is different from the polarization axis of the second polarizing film 210 by 90 degrees.

Next, the left image that passed through the second liquid crystal layer 120 passes through the second switching substrate 110. Like the first switching substrate 130, the second switching substrate 110 is a transparent substrate that includes a transparent electrode. Thus, the second switching substrate 110 may not have a polarizing function.

Consequently, when the left image that passed through the second polarizing film 210 passes through the polarizing panel 100, its polarization direction is rotated 90 degrees. Thus, the left image, which is polarized in a direction rotated 90 degrees to the polarization axis of the second polarizing film 210, reaches the polarized glasses 10.

As described above, the polarized glasses 10 include the first polarizing lens 11 and the second polarizing lens 12. The polarization axis of the first polarizing lens 11 is orthogonal to that of the second polarizing lens 12. Thus, the polarization direction of the left image that passed through the second switching substrate 110 is different from the direction of the polarization axis of the first polarizing lens 11, but is the same as the direction of the polarization axis of the second polarizing lens 12.

Consequently, while the viewer can see the left image with his left eye through the second polarizing lens 12, he cannot see the left image with his right eye. Since the viewer can see the left image with his left eye and the right image with his right eye, he can perceive a stereoscopic image with both eyes.

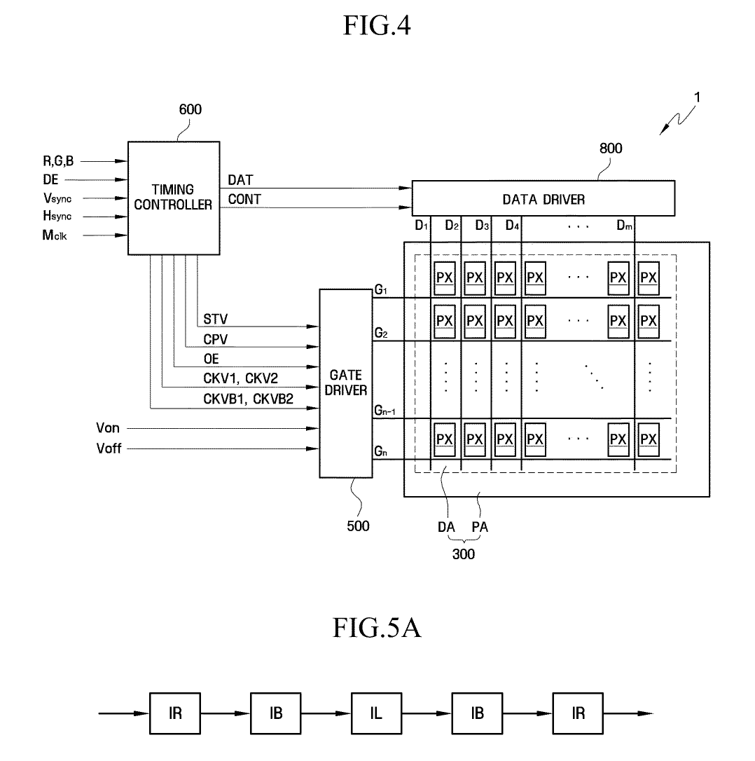

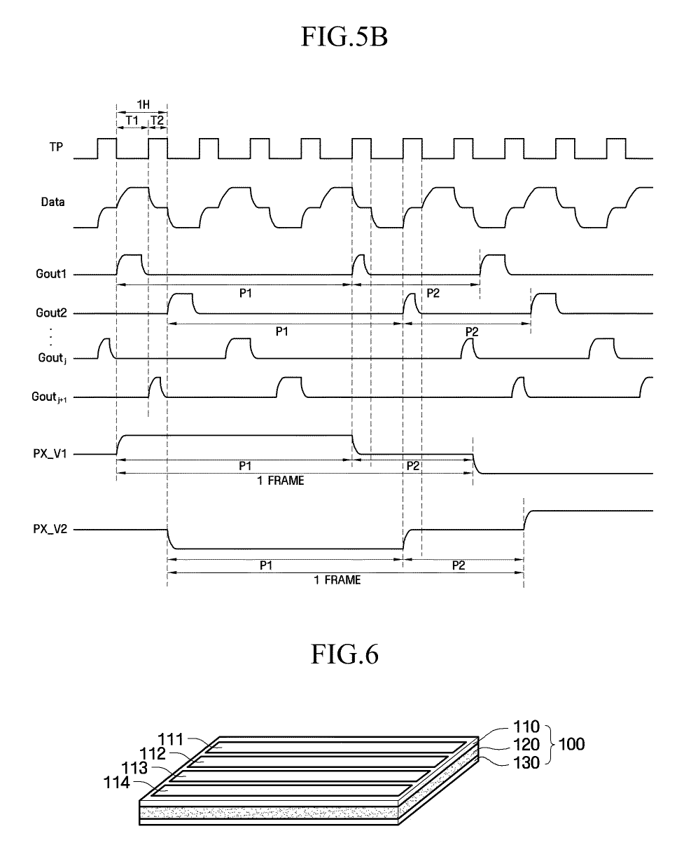

Hereinafter, a method of driving the display device 1 of FIG. 1 will be described in detail with reference to FIG. 4, FIG. 5A, and FIG. 5B. FIG. 4 is a schematic block diagram showing a method of driving the display device 1 shown in FIG. 1. FIG. 5A is a block diagram of an image signal transmitted to the display device 1 of FIG. 1. FIG. 5B shows waveforms of signals transmitted to the display device 1 of FIG. 1.

Referring to FIG. 4, the display device 1 according to the present exemplary embodiment includes the display panel 300, , a timing controller 600, a gate driver 500, and a data driver 800.

The liquid crystal panel 300 may be divided into a display region DA where images are displayed and a non-display region PA where no images are displayed.

The display region DA includes the lower display panel 330 (see FIG. 1) on which first through n^{th} gate lines G1 through Gn, a plurality of data lines D1 through Dm, a plurality of switching devices (not shown), and a plurality of pixel electrodes (not shown) are formed, the upper display panel 310 (see FIG. 1) on which a plurality of color filters (not shown) and a common electrode (not shown) are formed, and the first liquid crystal layer 320 (see FIG. 1), which is disposed between the lower and upper display panels 330 and 310. The first through n^{th} gate lines G1 through Gn extend in a row direction to be substantially parallel to each other, and the data lines D1 through Dm extend in a column direction to be substantially parallel to each other. In an exemplary embodiment, the plurality of color filters and the common electrode may be formed on the lower display panel 330. In an exemplary embodiment, the plurality of color filters may be formed on the lower display panel 330, and the common electrode may be formed on the upper display panel 310. In an exemplary embodiment, the plurality of color filters may be formed on the upper display panel 310, and the common electrode may be formed on the lower display panel 330.

The non-display region PA is where no images are displayed since the lower display panel 330 is wider than the upper display panel 310.

The timing controller 600 includes the clock generator 700. The timing controller 600 receives input image signals R, G, and B from an external graphics controller (not shown) and input control signals for controlling the display of the input image signals R, G, and B. Then, the signal provider provides image signals DAT and data control signals CONT to the data driver 800. Specifically, the timing controller 600 receives input control signals, such as a horizontal synchronization signal Hsync, a main clock signal Mclk, and a data enable signal DE, and outputs the data control signals CONT. The data control signals CONT are used to control the operation of the data driver 800 and include a horizontal start signal for starting the data driver 800 and a load signal TP for instructing the output of two data voltages.

The data driver 800 receives the image signals DAT and the data control signals CONT from the timing controller 600 and provides image data voltages, which correspond to the image signals DAT, to the data lines D1 through Dm, respectively. As integrated circuits (ICs), the data driver 800 may be connected to the liquid crystal panel 300 in the form of a tape carrier package (TCP). However, the present invention is not limited thereto. The data driver 800 may also be formed in the non-display region PA of the liquid crystal panel 300.

An image data voltage “Data” (see FIG. 5B) may include data on a left image and data on a right image. Thus, a left image data voltage and a right image data voltage may be alternately applied to each of the data lines D1 through Dm. The image data voltage “Data” will be described in detail below.

The timing controller 600 also receives a vertical synchronization signal Vsync and the main clock signal Mclk from the external graphics controller (not shown) and provides a clock signal CKV1, CKV2, a clock bar signal CKVB1, CKVB2, and the gate-off voltage Voff to the gate driver 500. Specifically, the timing controller 600 provides a start signal STV, a first clock generation control signal OE, and a second clock generation control signal CPV and outputs the clock signal CKV1, CKV2 and the clock bar signal CKVB1, CKVB2. The high level section of the clock signal CKV1, CKV2 do not overlap that of the clock bar signal CKVB1, CKVB2.

The gate driver 500 is enabled by the load signal TP, generates first through n^{th} gate signals Gout1 through Gout(n) by using the clock signal CKV1, CKV2, the clock bar signal CKVB1, CKVB2, and the gate-off voltage Voff, and sequentially transmits the first through n^{th} gate signals Gout1 through Gout(n) to the first through n^{th} gate lines G1 through Gn, respectively.

The image data voltage “Data” applied to each pixel PX will now be described in detail with reference to FIG. 4, FIG. 5A, and FIG. 5B.

When the image data voltage “Data” is applied to each pixel PX of the display panel 300, an image is displayed on the display panel 300. The image data voltage “Data” applied to each pixel PX includes image data of each pixel PX.

The display panel 300 sequentially displays a left image and a right image, each including a black image IB. To display a stereoscopic image, a left image captured at the position of the left eye of a viewer and a right image captured at the position of the right eye of the viewer are needed. As described above, the left and right images should be perceived by the left and right eyes of the viewer, respectively.

In order to display both of the left and right images on a single display panel 300, the left and right images may be sequentially displayed on the display panel 300, and polarization directions of the left and right images may be adjusted by using the polarizing panel 100. The left image includes a visible left display image IL and the black image TB that follows the left display image IL, and the right image includes a visible right display image IR and the black image IB that follows the right display image IR.

When the left image and the right image are not instantaneously separated from each other, the viewer may perceive the left image with his right eye or perceive the right image with his left eye. To prevent this situation, the black image IB may be inserted between the left display image IL and the right display image IR. For example, a frame may include the left display image IL and the black image IB, and the next frame may include the right display image IR and the black image IB.

Referring to FIG. 5A, an image signal, i.e., the image data voltage “Data,” may be transmitted to the display panel 300 while changing from the right display image IR to the black image IB, the left display image IL, the black image IB, and then back to the right display image IR. Here, the right display image IR and the left display image IL may each be part of a separate frame. The right display image IR and the black image IB may form one frame, and the left display image IL and the black image IB may form another frame. That is, no single image, that is, the right display image IR, the left display image IL, or the black image IB, may be displayed on the entire screen. Instead, at least one of the right display image IR and the left display image IL may be displayed on part of the screen, and the black image IB may be displayed on part of the screen in the form of a band. Alternatively, the right display image IR, the left display image IL, and the black image IB may be displayed together on part of the screen.

The process of charging each pixel PX with the image data voltage “Data” will now be described in detail with reference to FIG. 4 and FIG. 5B. During a frame, each pixel PX of the display panel 300 includes a display section P1 in which each pixel PX is charged with a visible image data voltage and a non-display section P2 in which the each pixel PX is charged with a black image data voltage. The same voltage is maintained in each of the display section P1 and the non-display section P2 before a next image signal is input to each pixel PX.

A pixel voltage PX_V1 and PX_V2, which is charged in each pixel PX in response to each signal, will now be described in detail. The gate driver 500 transmits the first through n^{th} gate signals Gout1 through Gout(n) to the first through nth gate lines G1 through Gn, respectively, in response to the load signal TP. The first through n^{th} gate signals Gout1 through Gout(n) switch on or off each thin film transistor. The load signal TP controls the voltage level of the image data voltage “Data” and may include an image-charging section T1 and a black image-charging section T2 in each period 1H.

In a section in which the load signal TP is at a low level, the image data voltage “Data” for the left display image IL or the right display image IR (hereinafter, referred to as a display image data voltage) may be charged. This section is referred to as the image-charging section T1. In addition, in a section in which the load signal TP is at a high level, the image data voltage “Data” for the black image IB (hereinafter, referred to as a black image data voltage) may be charged. This section is referred to as the black image-charging section T2. The black image data voltage may be the floating section of the image data voltage “Data”. That is, during the floating section, a common voltage which is applied to the common electrode may be transmitted to every data line. In one exemplary embodiment, during the floating section, every data line may be connected, and every data voltage charged in every data line may be shared.

Each gate signal may include one image-charging section T1 and one black image-charging section T2 in a frame. In a frame, the image-charging section T1 and the black image-charging section T2 may not be adjacent to each other. Instead, the image-charging section T1 and the black image-charging section T2 may be separated from each other by a period of time obtained by subtracting the image-charging section T1 from the display section P1. A gate signal transmitted to each pixel PX controls a switching device (not shown) which controls each pixel PX, and the switching device connected to each pixel PX may perform a switching operation twice during a frame.

A ratio of the image-charging section T1 to the black image-charging section T2 in each period 1H of the load signal TP may be adjusted. For example, the ratio of the image-charging section T1 to the black image-charging section T2 may be adjusted in consideration of a period of time required to charge each pixel PX with the display image data voltage in the image-charging section T1 and a period of time required to charge each pixel PX with the black image data voltage in the black image-charging section T2.

When the load signal TP transits to a low level, the image-charging section T1 begins, and a pixel PX is charged with the display image data voltage.

When the load signal TP transits to a next high level, the image-charging section T1 ends. Thus, the pixel PX is no longer charged with the display image data voltage. Each pixel PX is charged to the level of the display image data voltage and remains charged to the level during the display section P1. The pixel voltage PX_V1 and PX_V2 charged in each pixel PX includes a series of the display section P1 in which the display image data voltage is charged and the non-display section P2 in which the black image data voltage is charged. A voltage equal to the display image data voltage is maintained in the display section P1 until the non-display section P2 begins.

At a time when the display section P1 ends, the load signal TP transits to a high level. When the load signal TP transits to a high level, the black image-charging section T2 begins.

As the load signal TP transits to a high level, the pixel PX is charged with the black image data voltage. Here, the black image data voltage charged in the pixel PX remains unchanged during the non-display section P2. That is, a voltage equal to the black image data voltage is maintained during the non-display section P2 until the display section P1 of a next frame begins.

A ratio of the display section P1 to the non-display section P2 in a frame can be adjusted as desired. For example, when the display device 1 luminance can be maintained sufficiently high, the display section P1 may be reduced while the non-display section P2 is increased. When the display panel 300 is divided into a plurality of segments, the length of the non-display section P2 may be reduced according to the number of segments.

In the image-charging section T1 of the load signal TP, the display image data voltage has a level for displaying the left display image IL and the right display image IR. In the black image-charging section T2 of the first start signal TP, the black image data voltage has a level for displaying the black image IB. For example, in a normally black mode in which no electric field is applied to liquid crystal molecules (not shown) and thus the black image IB is displayed, the level of the black image data voltage for displaying the black image IB may be equal to that of a reference voltage. In addition, the level of the display image data voltage for displaying the left display image IL and the right display image IR may be higher than that of the reference voltage, and the level of the display image data voltage for displaying the left display image IL and the right display image IR, which is transmitted to a next gate line, may be lower than that of the reference voltage. That is, the level of the display image data voltage may be inverted, based on the level of the black image data voltage.

The first through n^{th} gate signals Gout1 through Gout(n) are sequentially transmitted to the first through n^{th} gate lines G1 through Gn, respectively, that is, one by one in each period 1H of the start signal STV. For example, the first gate signal Gout1 transits to a high level in the image-charging section T1 of the load signal TP and then transits to a low level in the black image-charging section T2 that follows the image-charging section T1. In a next image-charging section T1 of the first start signal TP, the second gate signal Gout2 transits to a high level and then transits to a low level in the following black image-charging section T2. In this way, the first through n^{th} gate signals Gout1 through Gout(n) are sequentially transmitted up to the n^{th} gate line Gn.

In the black image-charging section T2 between the image-charging section T1 of the first gate signal Gout1 and the image-charging section T1 of the second gate signal Gout2, the black image data voltage of the j^{th} gate signal Gout(j) may be charged. In the black image-charging section T2 that follows the image-charging section T1 of the second gate signal Gout2, the black image data voltage of the (j+1)^{th} gate signal may be charged.

As described above, the ratio of the display section P1 to the non-display section P2 can be adjusted as desired. When the display section P1 is increased, the display device 1 luminance may be increased. In this case, however, the left display image IL and the right display image IR may be mixed with each other and thus seen simultaneously. On the other hand, when the non-display section P2 is increased, the left display image IL can be clearly separated from the right display image IR. However, the display device 1 overall luminance may be reduced. Thus, the length of the display section P1 and that of the non-display section P2 may be adjusted as desired.

An image signal having 60 to 120 frames per second may be transmitted to each pixel PX of the display panel 300. In addition, the image data voltage “Data” may be inverted every frame and applied accordingly.

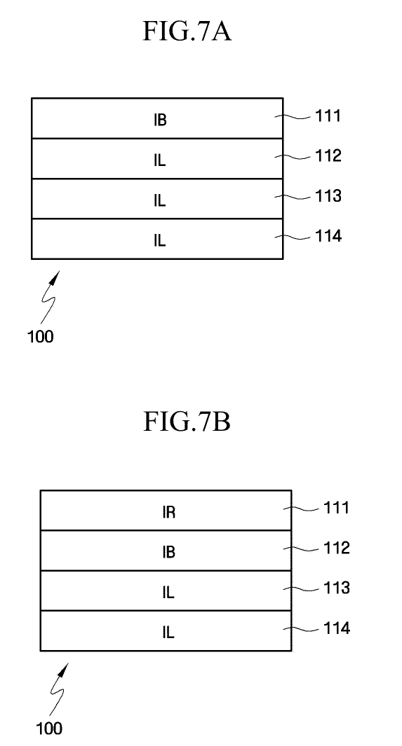

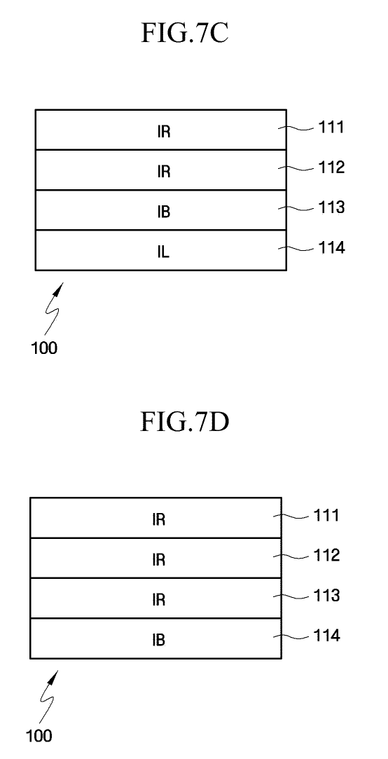

Hereinafter, a display device according to another exemplary embodiment of the present invention will be described in detail with reference to FIG. 6, FIG. 7A, FIG. 7B, FIG. 7C, and FIG. 7D. FIG. 6 is a perspective view of a polarizing panel 100 included in a display device according to another exemplary embodiment of the present invention. FIG. 7A, FIG. 7B, FIG. 7C, and FIG. 7D are plan views of the display device showing a process of displaying a left image and a right image on the display panel 300 shown in FIG. 6. For simplicity, elements having the same functions as those shown in the drawings for the previous exemplary embodiment are indicated by like reference numerals, and thus their description will be omitted.

The display device according to the present exemplary embodiment includes the polarizing panel 100 which is divided into a plurality of switching surfaces, i.e., first through fourth switching surfaces 111 through 114. The first through fourth switching surfaces 111 through 114 of the polarizing panel 100 may operate independently of each other. In addition, each of the first through fourth switching surfaces 111 through 114 may adjust a polarization direction of each of a left image and a right image. In the present exemplary embodiment, the display device including the polarizing panel 100, which is divided into the four switching surfaces 111 through 114, will be described.

The polarizing panel 100 is divided into four switching surfaces, i.e., the first through fourth switching surfaces 111 through 114. The first through fourth switching surfaces 111 through 114 operate independently of each other and independently control the polarization direction of light that passes therethrough. The first through fourth switching surfaces 111 through 114 may be formed parallel to gate lines and sequentially change the polarization directions of the left image and the right image in a direction parallel to data lines.

The first through fourth switching surfaces 111 through 114 may be formed by dividing a transparent electrode of at least one of a first switching substrate 130 and a second switching substrate 110 into four regions. A voltage may be applied to each region of the transparent electrode to control each of the first through fourth switching surfaces 111 through 114.

The first through fourth switching surfaces 111 through 114 operate sequentially to efficiently separate the left image from the right image.

Referring to FIG. 7A, a left display image IL is displayed in regions of the display panel 300 (see FIG. 1) that overlap the second through fourth switching surfaces 112 through 114, and a black image IB is displayed in a region of the display panel 300 that overlaps the first switching surface 111. Here, the second through fourth switching surfaces 112 through 114 of the polarizing panel 100 rotate a polarization direction of the left display image IL by 90 degrees.

Specifically, when the left display image IL is displayed in the regions of the display panel 300 that overlap the second through fourth switching surfaces 112 through 114, the second through fourth switching surfaces 112 through 114 of the display panel 300 rotate the polarization direction of the left display image IL by 90 degrees, so that a viewer can see the left display image IL with his left eye through polarized glasses 10.

Here, the black image IB is displayed in the region of the display panel 300 that overlaps the first switching surface 111. Since the viewer cannot see the black image IB, the first switching surface 111 on which the black image IB is displayed may have any polarization direction.

Referring to FIG. 7B, a right display image IR is displayed after the black image IB. That is, the right display image IR is displayed in the region of the display panel 300 that overlaps the first switching surface 111, and the black image IB is displayed in a region of the display panel 300 that overlaps the second switching surface 112.

The left display image IL previously displayed in the region of the display panel 300 that overlaps the second switching surface 112 disappears as pixels are charged with an image data voltage for the black image IB. In addition, the black image IB previously displayed in the region of the display panel 300 that overlaps the first switching surface 111 changes to the right display image IR as pixels are charged with an image data voltage for the right display image IR.

Here, the first switching surface 111 rotates a polarization axis of the polarizing panel 100 by 90 degrees to allow only the right display image IR to pass therethrough. Therefore, the viewer can see the right display image IR on the first switching surface 111 with his right eye, but not with his left eye.

On the other hand, the viewer can see the black image IB on the second switching surface 112 with his left and right eyes, regardless of the direction of the polarization axis of the second switching surface 112. Seeing the black image lB is substantially the same as seeing no pixels.

Since the left display image IL is displayed in the regions of the display panel 300 that overlap the third and fourth switching surfaces 113 and 114, the third and fourth switching surfaces 113 and 114 adjust the polarization direction of the left display image IL so that the viewer can see the left display image IL.

Referring to FIG. 7C, the right display image IR is displayed in regions of the display panel 300 that overlap the first and second switching surfaces 111 and 112, the black image IB is displayed in the region of the display panel 300 that overlaps the third switching surface 113, and the left display image IL is displayed in the region of the display panel 300 that overlaps the fourth switching surface 114.

Here, the first and second switching surfaces 111 and 112 adjust the polarization direction of the right display image IR so that the viewer can see the right display image IR, and the fourth switching surface 114 adjusts the polarization of the left display image IL so that the viewer can see the left display image IL. On the other hand, the black image IB is displayed on the third switching surface 113 regardless of the direction of the polarization axis of the polarizing panel 100.

Referring to FIG. 7D, the right display image IR is displayed in the regions of the display panel 300 that overlap the first through third switching surfaces 111 through 113, and the black image IB is displayed in the region of the display panel 300 that overlaps the fourth switching surface 114.

Here, the first through third switching surfaces 111 through 113 adjust the directions of their polarization axes so that the viewer can see the right display image IR. On the other hand, the black image IB is displayed on the fourth switching surface 114 regardless the direction of the polarization axis of the polarizing panel 100.

Referring back to FIG. 7A through FIG. 7D, when the polarizing panel 100 is divided into the first through fourth switching surfaces 111 through 114, a ratio of a display section P1 (see FIG. 5B) to a non-display section P2 (see FIG. 5B) may be 3:1. Therefore, a section in which the black image IB is displayed occupies only a quarter of a frame, and thus the black image IB is displayed in a region that corresponds to a quarter of the display panel 300. Accordingly, the right display image IR and the left display image IL are displayed in the remaining region which corresponds to three quarters of the display panel 300. A ratio of the region of the display panel 300 in which the left display image IL and the right display image IR are displayed to the region of the display panel 300 in which the black image IB is displayed may always be maintained at 3:1.

The present exemplary embodiment has been described above by using a case where the polarizing panel 100 is divided into four surfaces, i.e., the first through fourth switching surfaces 111 through 114 as an example. When the polarizing panel 100 is divided into more than four switching surfaces, the section in which the black image IB is displayed may be reduced. For example, when the polarizing panel 100 is divided into n switching surfaces, a ratio of the display section P1 to the non-display section P2 in a frame may be maintained at n-1:1.

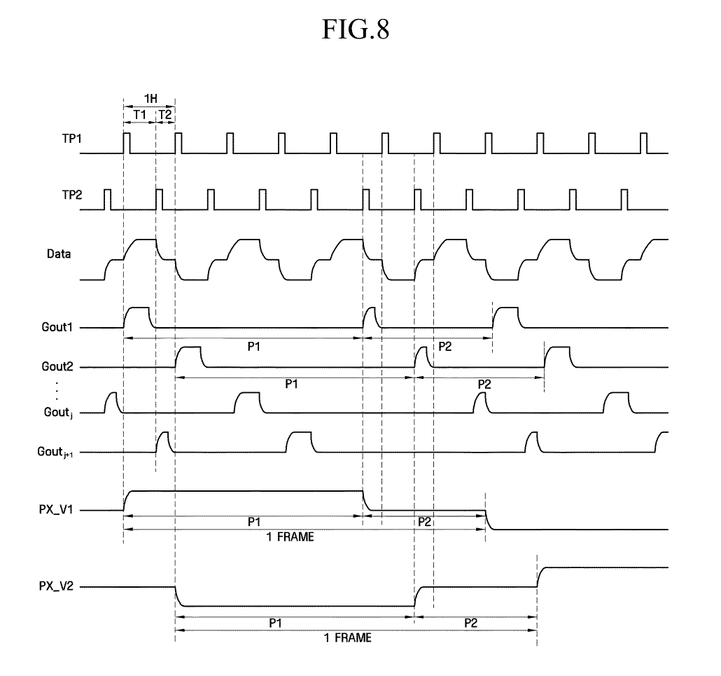

A method of driving the display device of FIG. 6 will now be described in detail with reference to FIG. 8. FIG. 8 shows waveforms of signals transmitted to the display device according to another exemplary embodiment of the present invention.

The display device shown in FIG. 6 controls a start point of a section in which a display image data voltage is charged and a section in which a black image data voltage is charged.

Each of a first load signal TP1 and a second load signal TP2 transmits a short pulse signal at regular intervals, i.e., in each period 1H. The first load signal TP1 initiates an image-charging section T1, and the second load signal TP2 initiates a black image-charging section T2.

A gate signal may include one image-charging section T1 and one black image-charging section T2 in a frame. In a frame, the image-charging section T1 and the black image-charging section T2 may not be adjacent to each other. Instead, the image-charging section T1 and the black image-charging section T2 may be separated from each other by a period of time obtained by subtracting the image-charging section T1 from the display section P1.

A ratio of the image-charging section T1 to the black image-charging section T2 can be adjusted by controlling the transmission time of the first load signal TP1 and that of the second load signal TP2.

When the first load signal TP1 is input, the image-charging section T1 begins, and each pixel PX is charged with the image data voltage “Data”.

When the second load signal TP2 is input, the image-charging section T1 ends, and the pixel PX is no longer charged with the display image data voltage. Each pixel PX is charged to the level of the display image data voltage and remains charged to the level during the display section P1. A pixel voltage PX_V1 and PX_V2 charged in each pixel PX includes a series of the display section P1 in which the display image data voltage is charged and the non-display section P2 in which the black image data voltage is charged. A voltage equal to the display image data voltage is maintained in the display section PI until the non-display section P2 begins.

As the first gate signal Gout1 again transits to a high level, the pixel PX is charged with the black image data voltage. Here, the black image data voltage charged in the pixel PX is maintained at a constant level during the non-display section P2. That is, a voltage equal to the black image data voltage is maintained during the non-display section P2 until the display section P1 of a next frame begins.

A ratio of the display section P1 to the non-display section P2 in a frame can be adjusted as desired.

The image-charging section T1 and the black image-charging section T2 can be controlled by charging the display image data voltage and the black image data voltage independently by using the first load signal TP1 and the second load signal TP2.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a display panel that sequentially displays a left image, a black image a right image, and the black image; and
a polarizing panel disposed on the display panel, the polarizing panel to change a polarization direction of at least one of the left image and the right image so that the polarization directions of the left image and the right image are different from each other.

2. The device of claim 1, wherein one of the polarization direction of the left image and the polarization direction of the right image is changed into the other of the polarization direction of the left image and the polarization direction of the right image every frame, and a frame comprises a display section in which one of the left image and the right image is displayed and a non-display section in which the black image is displayed.

3. The device of claim 2, wherein the display panel comprises:
a lower display panel;
an upper display panel;
a first polarizing film disposed under the lower display panel; and
a second polarizing film disposed on the upper display panel.

4. The device of claim 3, wherein the display panel further comprises:
a plurality of pixels that display the left image and the right image; and
a plurality of switching devices that control the pixels, respectively,
wherein each of the switching devices performs a switching operation twice in the frame.

5. The device of claim 1, wherein the polarizing panel comprises:
a first switching substrate;
a second switching substrate; and
a liquid crystal layer disposed between the first switching substrate and the second switching substrate.

6. The device of claim 1, wherein the polarizing panel changes the polarization directions of the left image and the right image in an alternating fashion.

7. The device of claim 6, wherein the left image and the right image that pass through the polarizing panel have a phase difference of 90 degrees.

8. The device of claim 1, wherein the polarizing panel comprises a plurality of switching surfaces that operate independently of each other.

9. The device of claim 8, wherein the display panel further comprises gate lines and data lines that cross each other, wherein the switching surfaces are separated from each other and are arranged parallel to the gate lines.

10. The device of claim 9, wherein the switching surfaces sequentially change the polarization directions of the left image and the right image in a direction parallel to the data lines.

11. The device of claim 9, wherein the polarization directions of the left image and the right image are changed by each switching surface, and a frame comprises a display section in which one of the left image and the right image is displayed and a non-display section in which the black image is displayed, wherein when the number of switching surfaces is n, a ratio of the display section to the non-display section is n-1:1.

12. A method of driving a display device, the method comprising:
sequentially displaying a left image, a black image, a right image and the black image on a display panel;
passing the left image and the right image displayed on the display panel through a polarizing film to polarize the left image and right image; and
passing the left image and the right image, which passed through the polarizing film, through a polarizing panel to change a polarization direction of at least one of the left image and the right image so that polarization directions of the left image and the right image are different from each other.

13. The method of claim 12, wherein one of the polarization direction of the left image and the polarization direction of the right image is changed into the other of the polarization direction of the left image and the polarization direction of the right image every frame, and a frame comprises a display section in which one of the left image and the right image is displayed and a non-display section in which the black image is displayed.

14. The method of claim 13, wherein the display panel performs a switching operation twice in the frame to control each of the display section and the non-display section.

15. The method of claim 12, wherein the polarizing panel changes the polarization directions of the left image and the right image in an alternating fashion.

16. The method of claim 15, wherein the polarizing panel is controlled to allow the left image and the right image that passed therethrough to have a phase difference of 90 degrees.

17. The method of claim 12, wherein the polarizing panel comprises a plurality of switching surfaces that operate independently of each other.

18. The method of claim 17, wherein the display panel further comprises gate lines and data lines that cross each other, wherein the switching surfaces are separated from each other and are arranged parallel to the gate lines.

19. The method of claim 18, wherein the switching surfaces sequentially change the polarization directions of the left image and the right image in a direction parallel to the data lines.

20. The method of claim 18, wherein the polarization directions of the left image and the right image are changed by each switching surface, and a frame comprises a display section in which one of the left image and the right image is displayed and a non-display section in which the black image is displayed, wherein when the number of switching surfaces is n, a ratio of the display section to the non-display section is n-1:1.
